(19) United States
(12) Patent Application Publication
(10) Pub. No.: US 2012/0075898 A1
(43) Pub. Date: Mar. 29, 2012

(54) Photovoltaic Power Converters and Closed Loop Maximum Power Point Tracking

(75) Inventors: James Sigamani, Pasig City (PH); Yancy F. Boncato, Quezon City (PH)

(73) Assignee: ASTEC INTERNATIONAL LIMITED, Kwun Tong (HK)

(21) Appl. No.: 12/892,646

(22) Filed: Sep. 28, 2010

(51) Int. Cl. H02M 7/48

(52) U.S. Cl. 363/131

(57) ABSTRACT

Power converters for photovoltaic (PV) systems and maximum power point tracking techniques are disclosed. One example power converter for a PV system includes an input for coupling to the PV system, an output for providing an output voltage, and a switch coupled between the input and the output. The input is configured to receive an input voltage (Vin) and input current (Iin) from the PV system. The power converter includes a controller configured for controlling operation of the switch using a control signal C. C is a function of at least the input voltage, the input current and a variable (K).

### FIELD

The present disclosure relates to photovoltaic power converters and closed loop maximum power point tracking.

### BACKGROUND

This section provides background information related to the present disclosure which is not necessarily prior art.

Photovoltaic (PV) cells, also commonly known as solar cells, generate electrical power from light energy. PV cells may be used individually or, coupled together in an array. PV cells have an operating point at which the values of current and voltage output by the PV cell will result in a maximum power output. This point is commonly referred to as the maximum power point (MPP). The MPP for a particular cell varies depending on the conditions in which the PV cell is operating. For example, the amount of irradiation on the PV cell, the temperature of the PV cell, etc. will affect the location of the MPP.

Various maximum power point tracking (MPPT) techniques are used in PV systems to maximize the PV array output power by tracking continuously the MPP. Some known MPPT use open loop control methods, such as perturb and observe, incremental conductance, etc. These open loop control methods tend to operate the PV cell(s) to oscillate around the MPP (typically without ever settling at the MPP for an extended period of time). In some instances, some of the known open loop control methods may slip away from the MPP when changes in the conditions (e.g., temperature, irradiation, etc.) are rapid.

### SUMMARY

This section provides a general summary of the disclosure, and is not a comprehensive disclosure of its full scope or all of its features.

According to one aspect of the present disclosure, a power converter for a photovoltaic (PV) system is disclosed. The power converter includes an input for coupling to the PV system. The input is configured to receive an input voltage (Vin) and input current (Iin) from the PV system. The power converter includes an output for providing an output voltage and a switch coupled between the input and the output. The power converter includes a controller configured for controlling operation of the switch using a control signal C. C is a function of at least the input voltage, the output voltage and a variable (K).

According to another aspect, a power converter for a photovoltaic (PV) system includes an input for coupling to the PV system. The input is configured to receive an input voltage and input current from the PV system. The power converter includes an output for providing an output voltage to a load and a switch coupled between the input and the output. The power converter includes a controller configured for controlling operation of the switch to operate the PV system at a maximum power point. The controller controls operation of the switch as a function of at least the input voltage, the output voltage and a variable maximum power set point (K). The controller is further configured to control the load to control the output voltage of the power converter.

Some example embodiments of power converters and PV systems incorporating one of more of these aspects are described below. Additional aspects and areas of applicability will become apparent from the description below. It should be understood that various aspects of this disclosure may be implemented individually or in combination with one or more other aspects. It should also be understood that the description and specific examples herein are provided for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a simplified diagram of a photovoltaic system according to various aspects of the present disclosure.

FIG. 2 is a basic representation an example PI controller for use in the system of FIG. 1.

FIG. 3 is an example block diagram of a circuit for determining an MPPT variable for the system of FIG. 1.

FIG. 4 are example IV curves for a thin film PV cell at twenty-five degree Celsius cell temperature for various levels of irradiance.

FIG. 5 is a diagram of another photovoltaic system according to aspects of the present disclosure.

FIG. 6 is the system of FIG. 5 with an adjustable load and a load control block.

FIG. 7 is a diagram of another photovoltaic system according to aspects of the present disclosure using average current mode control.

FIG. 8 block schematic of a grid-tie PV system according to aspects of the present disclosure.

FIG. 9 is a PV system including a non-isolated grid-tied inverter according to aspects of the present disclosure.

FIG. 10 is another grid-tied PV system according to aspects of the present disclosure.

FIG. 11 is a grid-tied inverter with average current mode control according to various aspects of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

According to an aspect of this disclosure, maximum power point tracking (MPPT) is accomplished by finding the maximum power point (MPP) and regulating the output voltage of a photovoltaic (PV) cell to the MPP using a closed loop control algorithm.

The method may include regulating the PV cell output voltage by adjusting the current drawn from the PV cell.

The MPP may be determined continuously or periodically. For example, the MPP may be redetermined after a triggering event occurs. The triggering event may be the passage of a defined period of time, the occurrence of a particular change, etc. Changes that may be triggering events include, for example, a change in the PV cell's output voltage, output current, output power, etc. exceeding a threshold value.

Closed loop control of the PV cell output voltage may enable the PV cell output to stay in the close vicinity of the MPP even during fast changes in irradiation. For example, when the irradiation increases, the MPP will generally shift to a higher output current. The PV cell will also generate more current at a given output voltage. Closed loop regulation of the PV cell output voltage may automatically pull more current from the PV cell to prevent the PV cell output voltage from rising. Eventually, the MPPT algorithm will adjust the PV cell output voltage to the new MPP.

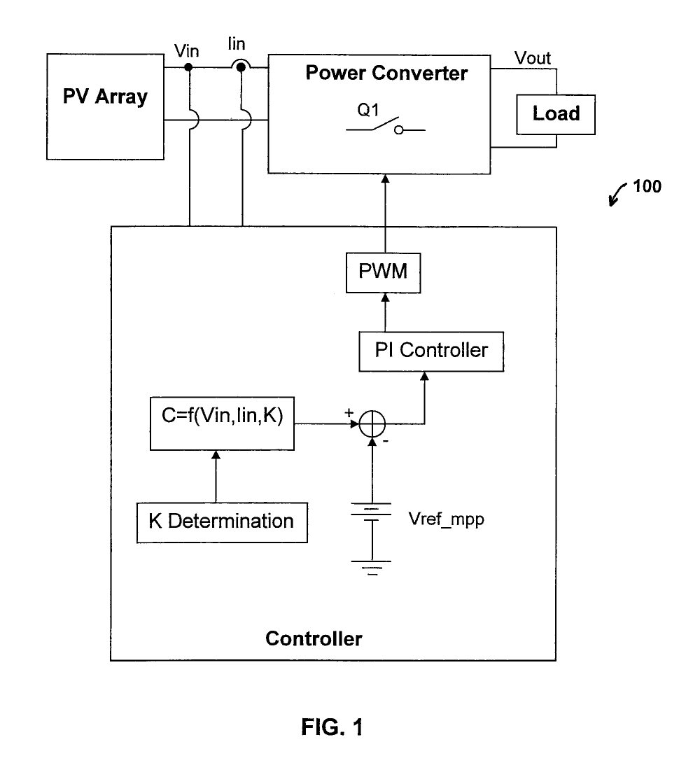

FIG. 1 is a simplified diagram of a system 100 that implements an aspect of the present disclosure. A photovoltaic array supplies an input voltage and an input current to an input of a power converter. The power converter includes an output for providing an output voltage to a load. The power converter includes a switch Q1 coupled between the input and the output. A controller is configured to control operation of the switch Q1 using a control signal C. C is a function of the input voltage, the input current and a variable K.

The power converter may be any type of power converter including, for example, a buck converter, a boost converter, etc. The power converter may include one or more inductors, capacitors, diodes, etc. that are not shown. The average current passing through the power converter, and thus the average current drawn from the PV array, is generally proportional to the duty cycle of the switch Q1.

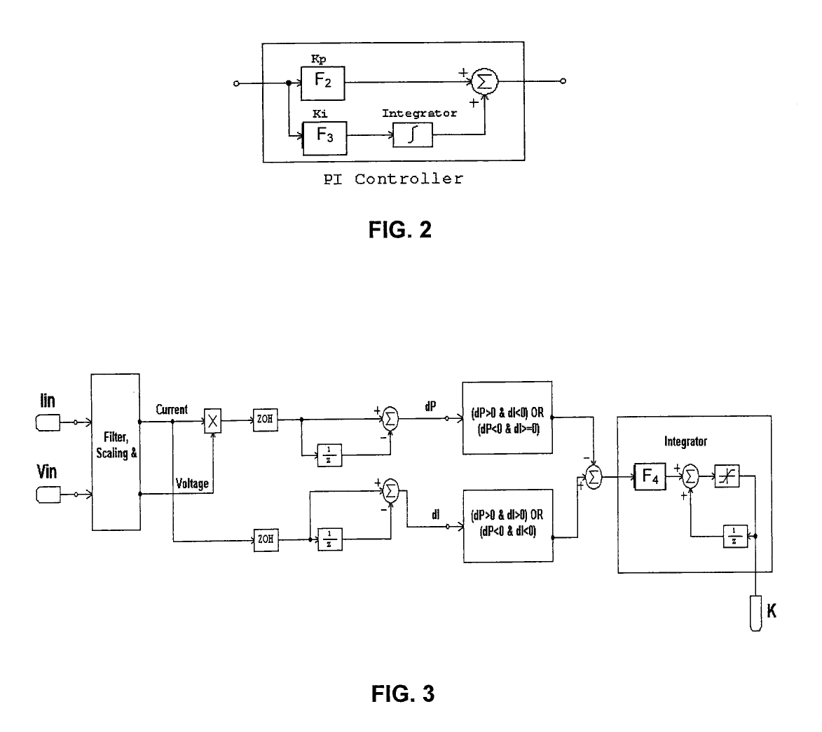

The duty cycle of the switch Q1 is controlled by a closed loop control system. The error signal of the loop is generated by subtracting a fixed reference voltage Vref_mpp from the control signal C. The error signal is fed into a PI controller, which controls the PWM signal provided to the switch Q1 to reduce the error signal to about zero. FIG. 2 is a basic representation an example PI controller for use in the system 100. F₂ and F₃ are scaling factors and may be the same or different. For a positive error signal, the PI controller will slowly increase the duty cycle of the PWM controller until the error signal is about zero. Conversely, for a negative error signal, the PI controller will slowly decrease the PWM signal until the error signal is about zero. Thus, the closed loop will force the control signal C to be equal to the reference voltage Vref_mpp. Alternatively, the controller may control the frequency of the switch rather than the duty cycle. In such a boundary conduction mode, the frequency of the switch will be changed depending on input/output ratio and the load.

The control signal C is a function of the PV array voltage Vin, a variable K, and to a lesser extent the PV array current Iin. The variable K is an MPPT variable. In various embodiments, the control signal C is expressed as C=(Vin*A)̂α*((Vin*A)̂β+δ*Iin*B)*K, where A and B are scale factors, α≧1, β≧1, and 0≧δ≧1. The values of α, β, and δ may be selected based on characteristics of the PV cell or PV array. For example, different values may be used for a crystal PV cell than are used for a thin-film PV cell. Higher δ will result in a higher C for a given K, and hence, will draw higher input current and will result in lower steady state input voltage. For any particular embodiment, these values, along with A and B, will be fixed values during operation of the power converter. Thus, while K is held constant, a change in the input current or input voltage to the converter will change the magnitude of C. The controller will, accordingly, adjust operation of the switch Q1 in the manner described above to cause the error signal to be about zero and, accordingly to return the input voltage to a desired level.

It also follows that changes in K will produce a change in the input voltage Vin, because a new input voltage Vin is required to satisfy C=Vref_mpp. Thus, changes to K change the setpoint of the closed loop.

In the circuit shown in FIG. 1, the input current Iin will automatically increase when the power generated by the PV array increases because the closed loop will automatically adjust the switching of the switch Q1 to regulate the input voltage Vin. In this way, the system 100 will generally track changes in the MPP of the PV cell. Because the control signal C is a function of the input voltage Vin and the input current Iin, the system 100 may more accurately track movement of the MPP than if C was only a function of Vin.

Because K acts like the setpoint of the control loop, the controller may perturb the input voltage Vin and the input current Iin by changing the value of K. The controller may then observe the power delivered by the PV cell (e.g. input voltage multiplied by input current) to decide if the new K provides more or less power than the old K. The controller will select the K that produces a higher power and continue to drive that K into the closed loop. Alternatively, or additionally, MPPT algorithms other than perturb and observe may be used to determine K.

One example for determining a value of K is illustrated in FIG. 3. The input voltage (Vin) and the input current (Iin) are filtered using a low pass filter and sampled at a 120 Hz rate. F₄ is a scaling factor. The quantities dP and dI are calculated by taking difference between two samples obtained at a 12 Hz interval. K is incremented or decremented based on conditions given as below:

| Condition | K |
|---|---|
| (dP > 0 & dI < 0) OR | Decrement |
| (dP < 0 & dI >= 0) | |
| (dP > 0 & dI > 0) OR | Increment |
| (dP < 0 & dI < 0) | |

In this way, the MPPT variable K enables the system to track the maximum power point of the PV array as the MPP drifts. The MPP may drift due to changes in irradiation, temperature of the PV array, etc. Note that, depending on how well the PV cell is heat-sinked, changes in irradiation may also cause changes in temperature because the PV cell will absorb some irradiation as heat. Changes in temperature commonly result in changes in the MPP.

The MPPT algorithm may run continuously, and thus update the MPPT variable K continuously, or may run and update the value of K periodically. Updating the variable K periodically may be more efficient because, assuming the MPP has not moved, the system 100 will spend the idle period operating at the MPP. In contrast, while seeking the MPP, the MPPT algorithm may perturb the input voltage Vin and move away from the MPP. Thus, if the MPP is relatively constant for a period of time, continuously varying K to find the MPP may cause the system 100 to oscillate about the MPP without settling on the MPP for any extended period of time.

When, instead, the controller updates the value of K periodically, the controller may wait a defined period of time, e.g. 5 seconds, 10 seconds, etc., a dynamically adjustable period of time, or may wait for triggering event. The idle time between updates of K may be dynamically adjusted based on, for example, the history of prior Ks. For example, if the last three determined K values were the same, the idle period may be extended. If the last three determined K values were different, the idle period may be shortened or skipped entirely until K settles down. Other triggering events may include, for example, a change in the input voltage, the input current, etc. reaching a defined threshold.

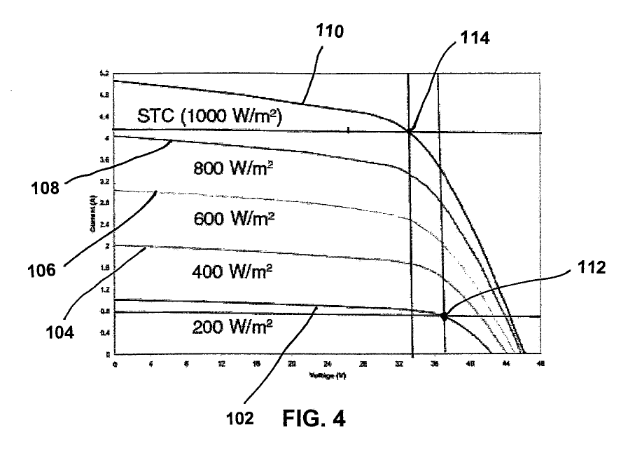

FIG. 4 illustrates example IV curves for a thin film PV cell at twenty-five degree Celsius cell temperature for various levels of irradiance. Trace 102 is the IV curve for an irradiance of 200 watts per meter squared (W/m²), trace 104 is the IV curve for an irradiance of 400 W/m², trace 106 is the IV curve for an irradiance of 600 W/m², trace 108 is the IV curve for an irradiance of 800 W/m², trace 110 is the IV curve for an irradiance of 1000 W/m². The MPP at 200 W/m² is about 37 volts and 0.8 amps at point 112. The MPP at 1000 W/m² irradiance is about 32.5 volts and 4.2 amps at point 114.

By way of example, assume the system 100 includes ten thin-film PV cells (each of which produces IV curves as shown in FIG. 4) connected in series. At 1000 W/m² irradiance, the MPP is 325V and at 200 W/m² irradiance, the MPP is 370V. Vref mpp is assigned a value of 2.5V, A equals 4.55*10⁻³, B equals 0.43, δ equals 1 and α and β equal 2. If the irradiance is 1000 W/m², the value of K that makes C equal to Vref_mpp is 0.286. If K does not change, when the irradiation is changed to 200 W/m², C will equal Vref_mpp when Vin is about 367V (i.e. close to 370V). Thus, even without changing K, this example system will provide fairly good tracking of the MPP. Further, changing K in the manner discussed above may result in more accurate tracking of the MPP.

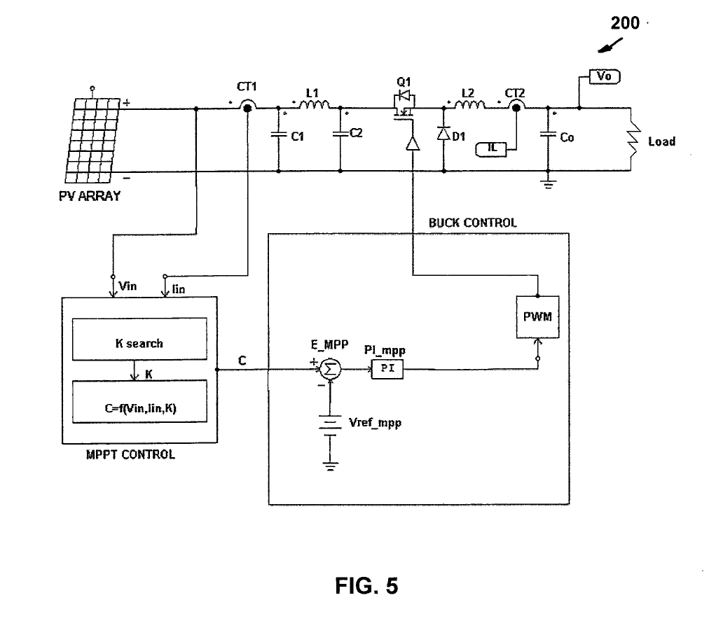

FIG. 5 shows another example system 200. A PV array is coupled to a load by a buck power converter. The power converter includes a switch Q1, a MPPT control block, and a buck control block. The buck control block and the MPPT control block may be separate controllers or part of a single controller.

The buck control block drives the switch Q1 with a switch drive signal generated by its PWM block. The PWM block is fed by a PI controller PI_mpp which receives an error signal from a summer E_MPP. The summer E_MPP compares a control signal C to a fixed reference Vref_mpp. In operation, the on-time of the switch Q1 increases as the control signal C increases.

The MPPT control block generates the control signal C, which is a function of the PV array voltage Vin, an MPPT variable K, and to a lesser extent the PV array current Iin. In this example, C=Vin*Vin*K. Thus, for a given K, the power converter will regulate the input power (Vin*Iin) due to the closed loop of the summer E_MPP, the PI controller PI_mpp, the PWM block, the switch Q1, and the MPPT control block. In this example, the output voltage Vout is unregulated and will vary as a function of the output current through the load.

The MPPT variable K is incremented and decremented by a MPPT algorithm such as, for example, Perturb and Observe, Incremental Conductance, etc. The PV array voltage will track changes in K due to the closed loop control described above.

In an alternative embodiment, the control signal C is given by C=Vin̂2*(Vin̂2+0.05*In)*K.

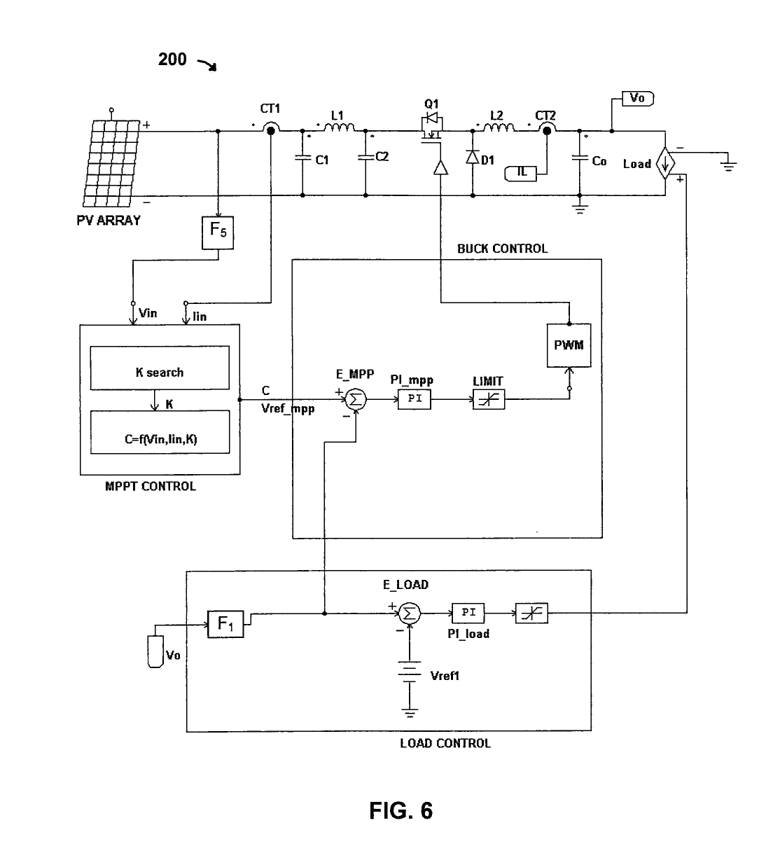

As shown in FIG. 6, the system 200 may have an adjustable load impedance. In such embodiments, the power converter output voltage Vo may be regulated by adjusting the load impedance using, for example, the load control block illustrated in FIG. 6. F₁ and F₅ are scaling factors and may be the same or different. The ‘Load’ in FIG. 6 represents the controlled current through the following stage, which can be, for example, an inverter with or without isolation. The load control block includes a summer E_LOAD and a PI controller PI_load that regulate the load such that the power drawn from the PV array is at maximum.

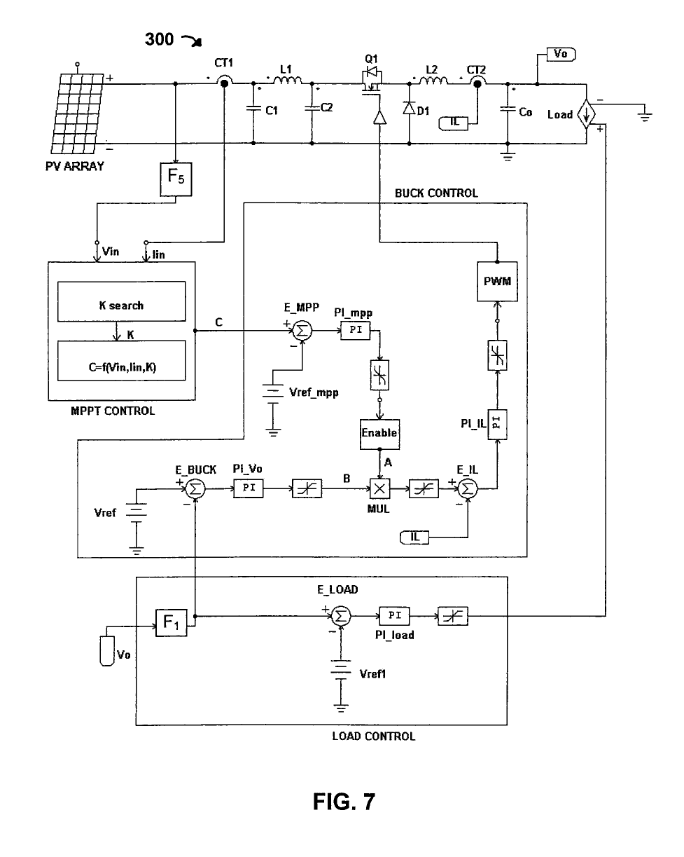

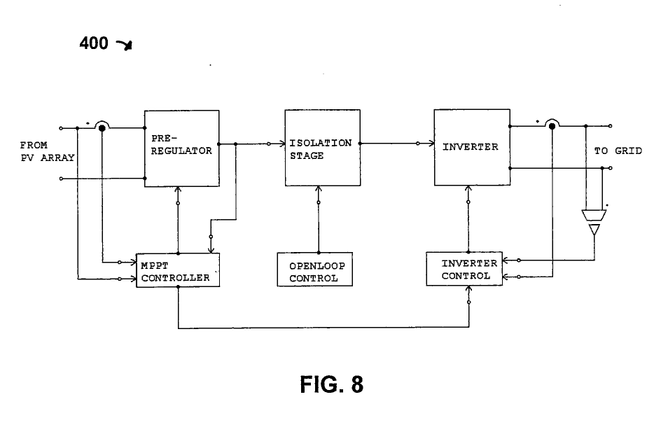

Another example system 300 is illustrated in FIG. 7. The system 300 includes a PV array providing power to a buck converter. The system 300 is controller by a controller including a MPPT control block, a buck control block and a load control block. The buck converter is coupled to provide power to a load.

The load attached to the buck converter in FIG. 7 represents the controlled current through a following stage, which can be, for example, an inverter with or without isolation. The load control block regulates the load such that the power drawn from the PV array is at maximum.

In general, the system 300 uses a closed loop control to regulate the output voltage (i.e. the voltage provided to the load) by adjusting the load impedance. The setpoint for the output voltage is fixed. The output current is regulated (closed loop) by adjusting the duty cycle of a switch Q1. The output current setpoint depends on the input voltage to the buck converter, the input current to the buck converter and a MPP variable K, which is set by a MPPT algorithm. The input voltage, (i.e., the PV array output voltage), is regulated closed loop by adjusting the output current (i.e. by adjusting the duty cycle of the switch Q1). The input voltage setpoint depends on the MPP variable K.

In the system 300, control of the buck converter is achieved using an average current mode control technique. Alternatively, another control method like voltage mode control, peak current mode control, etc. may be effectively employed.

The buck control has two modes of operation. In the first mode, the output voltage Vo is regulated by adjusting the on-time of a switch Q1. This mode is referred to as the startup mode. In the second mode, the output voltage Vo is regulated by a load control block as described below. This mode is referred to as the operational mode.

In the startup mode, summer E_BUCK compares the scaled output voltage Vo with fixed reference Vref and the error is fed to a PI controller PI_Vo, the output of which sets the buck inductor current reference B. In this mode, the MPPT is disabled and the signal A input to the multiplier MUL is equal to 1. Accordingly, the multiplier MUL output is B, which is compared with the inductor current IL. This error signal is fed to PI controller PI_IL which in turn controls the duty cycle of the buck through the PWM block. In this way, the buck control regulates the output voltage Vo.

In the operational mode, when MPPT is enabled, summer E_mpp computes the error between Vref_mpp and C and drives the PI controller PI_mpp. The output of PI_mpp alters the inductor current reference B through the multiplier MUL. In this mode, B is saturated and thus constant. However, signal A remains variable based on the difference between C and Vref_mpp. Accordingly, signal A, and indirectly C, still controls the inductor current. As a result, Vo will not follow Vref as it does in the startup mode. The limiter after PI_IL ensures Vo will not exceed a specified max voltage by limiting the PWM duty cycle when Vo reaches a defined maximum value. The value of Vref_mpp is selected such that, given the anticipated MPP voltage and current range, the value of C can be made equal to Vref_mpp by varying the value of K.

The load control block controls the load current of the buck converter. The output voltage Vo is compared with a fixed reference Vref1 by a summer E_load to generate an error signal. A PI controller PI_load process the error and regulates Vo by increasing/decreasing the load depending on whether Vo is more/less than Vref1. If Vref1 is chosen lower than Vref, the regulation of Vo by PI_load will force the output of PI_Vo to saturate as described above. For example, if Vref1=2.5V corresponds to a 400V output, Vref=2.6V will then correspond to 416V. Whenever Vo goes above 400V, PI_load will react and increase the load until Vo is brought back to 400V. As Vo is regulated at 400V, E_buck will have constant+ve error, which will drive PI_Vo to saturation. During startup, Vo is regulated to 416V, Vref1 is set initially to 2.6V and slowly decremented to 2.5V to initiate soft-start on the load.

The MPPT control block increments/decrements K until the input power (Vin times Iin) reaches the MPP. The MPPT control block provides the value of C to the buck control block, which increases/decreases the output voltage Vo by comparing C with fixed reference Vref_mpp.

As described above, during startup the PI controllers PI_mpp and PI_load are disabled and signal A is set to 1. The input voltage, which is the PV array output voltage, is measured and an initial value of K may be estimated assuming Iin=0 and Vin=0.85 of the actual scaled input voltage. Accordingly, the initial K may be set as K=Vref_mpp/(0.85*Vin)⁴. The initial K is computed by using 0.85 of the measured Vin because the MPP voltage of a PV cell is often 85% of the open circuit voltage. Incrementing/decrementing of K will start from this initial value when MPPT is enabled. This will result in an initial computed C value that is higher than Vref_mpp. Vref is slowly increased to required level, e.g. 2.6V, to achieve soft start. Once Vo is regulated to 416V, PI_mpp and PI_load are enabled, and signal A will follow the output of PI_mpp. Because Vo is more than Vref1, which is 2.5V, the load will increase until Vo equals 400V. During startup, the K value will be changed only when the input voltage is constant, which indicates a steady state condition. As the load increases, the input voltage will start falling until the computed value C becomes equal to Vref_mpp and the input voltage will be regulated at this level until the K value changes again. The input voltage will be regulated between instances of K incrementing/decrementing. K will be incremented/decremented, as explained with respect to the MPPT control block operation, until the MPP is reached.

During rapid irradiation changes, the system 300 automatically adjusts the load in the proper direction without the need for a change in K in response to the change in input voltage arising from the irradiation change. For example, if irradiation increases, input voltage will increase. This will result in an increased value of C, the effect of which is to increase the output voltage by increasing the inductor current. PI_load will increase the load to regulate the output voltage.

In some embodiments, 5-10 seconds of constant irradiation is sufficient for the system 300 to assign K to the MPP value. Once K is at the MPP, the load will follow changes in irradiation (as discussed above). Because changes in panel temperature will also change the MPP, K may be adjusted for the change in temperature. As the change in temperature of a PV panel is slow, there is plenty of time to adjust K in response to the slowly changing MPP.

FIG. 8 is a block schematic of a grid-tied PV system 400 where the power from a PV array is converted to AC power and supplied to utility.

The pre-regulator used in the above system can be a buck, boost or buck-boost converter which converts the PV array voltage to a level suitable for the isolation stage in isolated systems or to a level suitable for the inverter in the non-isolated systems. Any of the control techniques and MPPT tracking techniques described hereinabove and hereinafter may be used in the system 400.

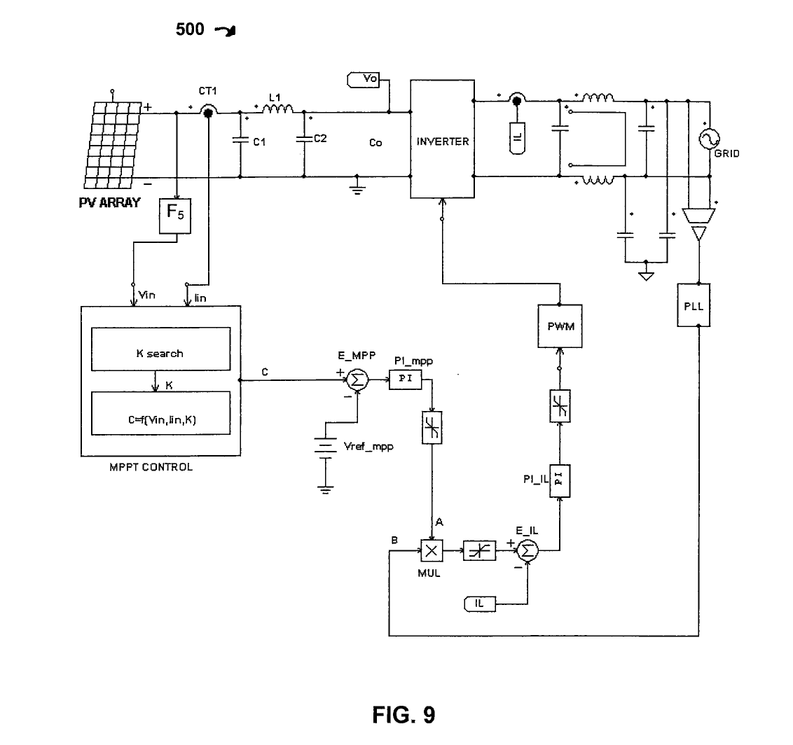

FIG. 9 is a PV system 500 including a non-isolated grid-tied inverter. The system includes a buck converter coupled between a PV array and an inverter block. The inverter is controlled with an average current mode control technique. PLL is used to generate a sinusoidal current reference in sync with the grid voltage. The command from the load control block is multiplied with the current reference to adjust the current to the grid. The rest of the operation of the system 500 is the same as explained above.

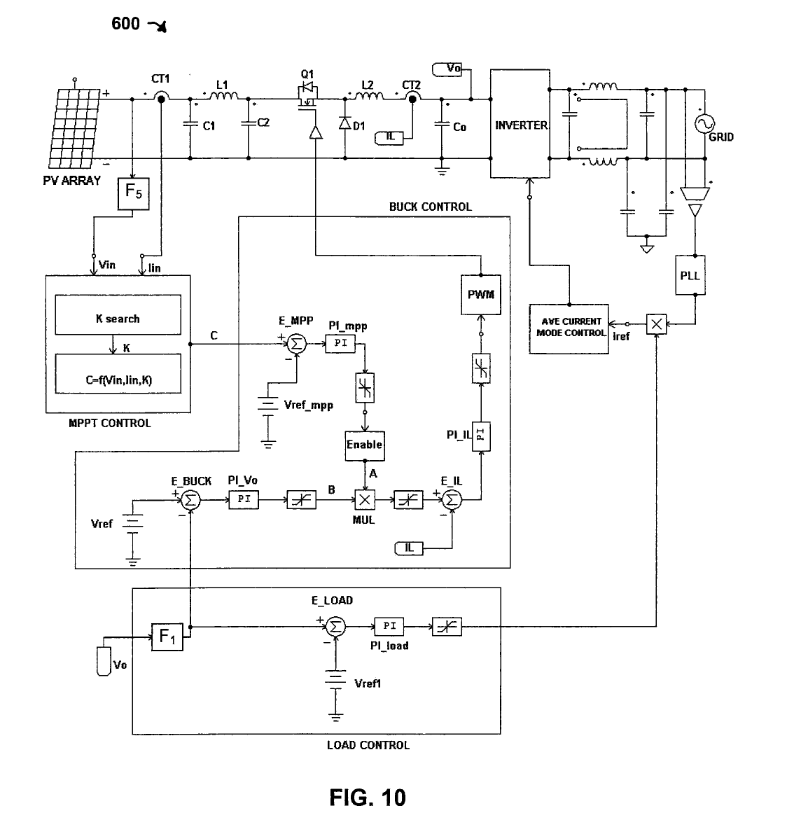

FIG. 10 is another PV system 600 according to the present disclosure. The system 600 includes a non-isolated grid-tied inverter operated directly from a PV input. The output voltage B of PLL is multiplied with the MPPT controller output A to set the output current reference. When K is zero, C will be zero and hence the output current will be zero. Increasing C beyond Vref_mpp will increase the output current. The K search block will continuously adjust C until the MPP is reached. Vref_mpp is selected such that the value of C can be made equal to Vref_mpp under all expected MPP conditions taking in to account expected temperature and irradiation changes. The rest of the operation of the system 600 is the same as explained above.

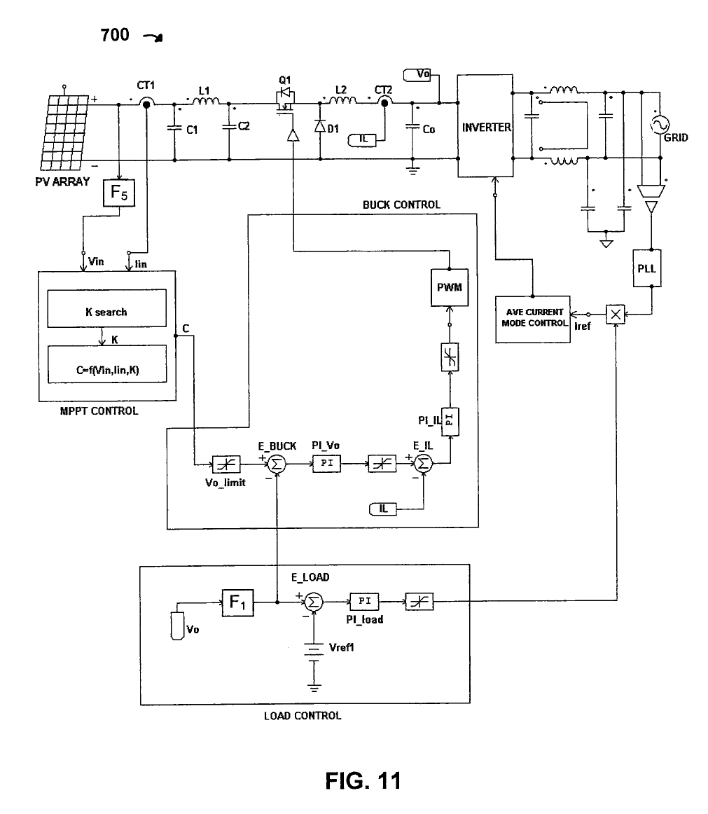

A system 700 including MPPT control of a grid-tied inverter with average current mode control is shown in FIG. 11. The control signal C from the MPPT control block is used as reference as in voltage mode control. During start up, a K value is computed using K=Vref1/Vin⁴, where Vin is the open circuit voltage of the PV array. K is slowly incremented to the computed K value to achieve soft start. At this point, the output voltage of the buck converter will correspond to the reference voltage Vref1. At this time, the value of K may be increased/decreased using the K search algorithm. An increase in the value of K will generate a positive error in E_load as the scaled value of the output voltage will be higher than Vref1. Accordingly, the inverter load will increase. Conversely, a decreasing value of K will generate a negative error in E_load and the inverter load will decrease. This incrementing/decrementing will continue until the MPP is reached.

The systems and methods described above may be used in any suitable application. For example, in some embodiments, the system is a micro inverter/converter, a solar battery charger, a stand alone inverter with PV input, etc.

The controllers and control blocks discussed above may be implemented in a single controller or in separate controllers. The controllers may be analog controllers, digital controllers and/or a combination of analog and digital controllers. The various control blocks discussed above may be implemented in numerous ways including, for example, in hardware, software, etc.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power converter for a photovoltaic (PV) system, the power converter comprising:
an input for coupling to the PV system, the input configured to receive an input voltage (Vin) and input current (Iin) from the PV system;
an output for providing an output voltage;
a switch coupled between the input and the output; and
a controller configured for controlling operation of the switch using a control signal C, C being a function of at least the input voltage, the input current and a variable (K).

2. The power converter of claim 1 wherein the controller is configured to determine a value of K using a maximum power point tracking (MPPT) algorithm.

3. The power converter of claim 2 wherein the MPPT algorithm is a perturb and observe algorithm.

4. The power converter of claim 2 wherein the MPPT algorithm is an incremental conductance algorithm.

5. The power converter of claim 2 wherein:
C=(Vin*A)^{α}*((Vin*A)^{β}+δ*Iin*B)*K,
where A and B are scale factors, α≧1, β≧1, 0≧δ≧1.

6. The power converter of claim 5 wherein A=B=1 and α=β=2.

7. The power converter of claim 2 wherein the controller is configured to substantially continuously re-determine the value of K.

8. The power converter of claim 2 wherein the controller is configured to the re-determine the value of K in response to a triggering event.

9. The power converter of claim 8 wherein the triggering event is the passage of a substantially fixed period of time following a last determination of the value of K.

10. The power converter of claim 8 wherein the triggering event is a change in a magnitude of the input voltage or the input current greater than a threshold value.

11. The power converter of claim 1 wherein the controller is configured to not monitor the output voltage.

12. The power converter of claim 1 wherein the controller is further configured to monitor the output voltage.

13. The power converter of claim 12 wherein the controller is configured to control the switch in response to C and the output voltage.

14. The power converter of claim 12 wherein the controller is further configured to control a load coupled to the output to control a magnitude of the output voltage.

15. A PV system including at least one PV cell and the power converter of claim 1.

16. A power converter for a photovoltaic (PV) system, the power converter comprising:
an input for coupling to the PV system, the input configured to receive an input voltage and input current from the PV system;
an output for providing an output voltage to a load;
a switch coupled between the input and the output; and
a controller configured for controlling operation of the switch to operate the PV system at a maximum power point, the controller controlling operation of the switch as a function of at least the input voltage, the input current and a variable maximum power set point (K), the controller further configured to control the load to control the output voltage of the power converter.

17. The power converter of claim 16 wherein the controller is further configured to periodically determine a value for K.

18. The power converter of claim 17 wherein the controller is configured to determine the value for K after a defined period of time has elapsed after the last determination of the value for K.

19. The power converter of claim 17 wherein the controller is configured to determine the value for K after a triggering event has occurred.
